(19) United States
(12) Patent Application Publication
(10) Pub. No.: US 2025/0223002 A1
(43) Pub. Date: Jul. 10, 2025

(54) FRAME ASSEMBLY FOR ELECTRIC MOTORCYCLE AND ELECTRIC MOTORCYCLE

(71) Applicant: HORWIN INC., Changzhou, (CN)

(72) Inventors: Wei LI, Changzhou (CN); Zefeng LIN, Changzhou (CN); Panhua ZENG, Changzhou (CN)

(73) Assignee: HORWIN INC., Changzhou, (CN)

(21) Appl. No.: 18/291,225

(22) PCT Filed: Dec. 25, 2023
(86) PCT No.: PCT/CN2023/141379

§ 371 Date: Jan. 23, 2024

(30) Foreign Application Priority Data
Sep. 15, 2023 (CN) 202311192869.6

(51) Int. Cl. B62K 11/04; B62J 43/16; B62J 43/20; B62K 19/24; B62M 7/02

(52) U.S. Cl. CPC B62K 11/04; B62J 43/16; B62J 43/20; B62K 19/24; B62M 7/02; B62K 2204/00

(57) ABSTRACT

The present disclosure provides a frame assembly of an electric motorcycle and the electric motorcycle. The frame assembly includes a first frame, a second frame, a battery, and a motor, where the first frame and the second frame are respectively mounted to the battery from a first side and a second side of the battery; the motor is mounted to the battery and/or the second frame from the second side; and the first side and the second side are opposite sides of the battery. By at least partially integrating a power system and a bearing system of the electric motorcycle together, the present disclosure can simplify an internal structure and a manufacturing cost of the electric motorcycle.

### TECHNICAL FIELD

The present disclosure relates to the field of motorcycles, and in particular to a frame assembly for an electric motorcycle and the electric motorcycle.

### BACKGROUND

This section is merely intended to provide background information related to the present disclosure, and does not necessarily constitute the prior art.

With better performance configurations of motorcycles and particularly electric motorcycles, there are increasingly high requirements on the bearing capacity and light weight of motorcycle bodies. In related art, a frame is usually welded by steel tubes. A battery and a motor are suspended on the steel-tube frame.

However, this frame may have the following problems. The frame manufactured with the steel tubes is heavy, such that more energy is consumed by the motorcycle in driving, and the endurance of the motorcycle is reduced. Due to welding between the steel tubes, the frame is manufactured cumbersomely. Moreover, due to suspension of the battery, the space of the battery in the motorcycle body is limited. Hence, the motorcycle can only be provided with a battery with a small size and a small capacity. This also causes poor endurance of the motorcycle.

### SUMMARY

An objective of the present disclosure is to provide a frame assembly of an electric motorcycle, to at least partially solve the above problems. The objective of the present disclosure can be achieved by the following technical solutions:

A first aspect of the present disclosure provides a frame assembly of an electric motorcycle, including a first frame, a second frame, a battery, and a motor, where the first frame and the second frame are respectively mounted to the battery from a first side and a second side of the battery; the motor is mounted to the battery and/or the second frame from the second side; and the first side and the second side are opposite sides of the battery. The battery and the motor are taken as one part of the frame assembly. The battery and the motor can be directly used to bear a weight, while a frame for mounting the battery and the motor is omitted. Therefore, the frame assembly can at least realize a light weight of the frame of the electric motorcycle, simplify a manufacturing process of the frame, and improve an endurance of the electric motorcycle.

A second aspect of the present disclosure provides an electric motorcycle including the frame assembly, where the electric motorcycle is preferably an electrically-driven motorcycle, or is referred to as an all-electric motorcycle. The electric motorcycle can be provided with the lightweight frame assembly. This not only can simplify a production process and a manufacturing process of the motorcycle and reduce a body weight of the motorcycle, but also can improve an endurance of the motorcycle.

### BRIEF DESCRIPTION OF THE DRAWINGS

By reading the detailed description of the following preferred implementations, various other advantages and benefits will become apparent to those of ordinary skill in the art. The accompanying drawings are provided merely to illustrate the preferred implementations, rather than to limit the present disclosure. Throughout the accompanying drawings, the same reference numerals represent the same components. In the accompanying drawings:

FIG. 1 is a schematic structural view of an electric motorcycle according to an implementation of the present disclosure;

FIG. 2 to FIG. 6 are a schematic view of a frame assembly of an electric motorcycle according to different implementations of the present disclosure;

FIG. 7 to FIG. 10 are a schematic structural view of a battery housing of a frame assembly according to different implementations of the present disclosure; and

FIG. 11 is a sectional view of a battery housing according to an implementation of the present disclosure.

### DETAILED DESCRIPTION OF THE EMBODIMENTS

Exemplary implementations of the present disclosure will be described below in more detail with reference to the accompanying drawings. Although the accompanying drawings show exemplary implementations of the present disclosure, it should be understood that the present disclosure may be implemented in various forms and should not be limited to the implementations set forth herein. On the contrary, these implementations are provided so that the present disclosure will be more fully understandable, and will fully convey the scope of the present disclosure to those skilled in the art.

It is to be understood that the terms used in the description of the present disclosure are for the purpose of describing specific exemplary implementations only and are not the limit to the present disclosure. As used herein, the singular forms such as “a”, “an” and “the” are intended to include the plural forms as well, unless the context clearly indicates otherwise. The terms “include”, “comprising” and “having” are inclusive, and specify the presence of stated features, elements, and/or components, but do not preclude the presence or addition of one or more other features, elements, components, and/or combinations thereof.

Although the terms such as first and second may be used herein to describe various elements, components, regions, layers and/or sections, these elements, components, regions, layers and/or sections should not be limited by these terms. These terms are only used to distinguish one element, component, region, layer or section from another region, layer or section. Unless the context clearly indicates otherwise, terms such as “first”, “second” and “third” and other numerical terms do not imply a sequence or an order in use. In addition, in the description of the present disclosure, unless otherwise clearly specified and limited, the meanings of terms “mounting” and “connection” should be understood in a broad sense. For example, the connection may be a fixed connection, a removable connection or an integrated connection, and may be a direct connection or an indirect connection via an intermediate medium. In the description of the present disclosure, unless otherwise clearly specified and limited, terms such as “fixed” indicate that a plurality of components are coupled or fixed according to technical requirements, to realize mechanical assembly without affecting correct relative positions and a correct mutual relationship, such as a mechanical connection between a bolt and a threaded hole. Those skilled in the art may understand specific meanings of the foregoing terms in the present disclosure based on a specific situation.

Spatially relative terms, such as “upper”, “middle”, “lower”, “inner” and “close”, may be used herein for ease of description to describe one element or feature's relationship to another element or feature as illustrated in the figures. The spatially relative terms are intended to encompass different orientations of the device in use or operation in addition to the orientation depicted in the figures. For example, if the device in the figures is turned over, elements described as “below” or “beneath” other elements or features would then be oriented “on” the other elements or features or “above” the other elements or features. Thus, the exemplary term “below” can encompass both an orientation of above and below. The device may be otherwise oriented (rotated 90 degrees or at other orientations) and the spatially relative descriptors used herein shall be interpreted accordingly.

In a related art, a frame of a conventional motorcycle is usually designed according to an oil tank and an engine, and is manufactured by welding steel tubes. In contrast, a power system of an electric motorcycle includes a battery and a motor. Since the battery has a larger size than an oil tank and is of an approximately cuboid shape in most cases, the frame of the fuel motorcycle cannot be directly applied to the electric motorcycle. Otherwise, the battery may have a limited size or capacity or the motorcycle may have a poor endurance.

Both the battery and the motor are crucial for the endurance, electric performance and power performance of the whole electric motorcycle. It is generally considered that the battery and the motor are power devices independent of the frame. In view of this, various frames (such as a battery frame, a battery accommodation case, a motor frame and a main frame) are designed to protect the battery and the motor. The battery and the motor are provided on the frame, so as not to apply an external load (such as a weight of a driver, a passenger or an accessory) to the battery or the motor as much as possible.

However, in order to overcome the above technical biases, it is found by an inventor that if the battery and the motor are taken as one part of the frame assembly, and are directly used as a structural member of the frame for bearing an external force, at least one of the following surprising technical effects can be achieved: First, by removing a part of frame members, the motorcycle is lightweight. Since the battery has a larger footprint in the motorcycle, an endurance of the motor can be prolonged. Second, various components are modularly combined, thereby completing assembly of the frame. This can simplify production and maintenance processes of the frame. Third, the power system and the bearing system of the electric motorcycle are at least partially integrated, such that the battery and the motor for providing a power can also be used for bearing a load. This not only simplifies an internal structure and a manufacturing cost of the electric motorcycle, but also improves function integration of the electric motorcycle.

Embodiments of the present disclosure are described below with reference to various exemplary drawings.

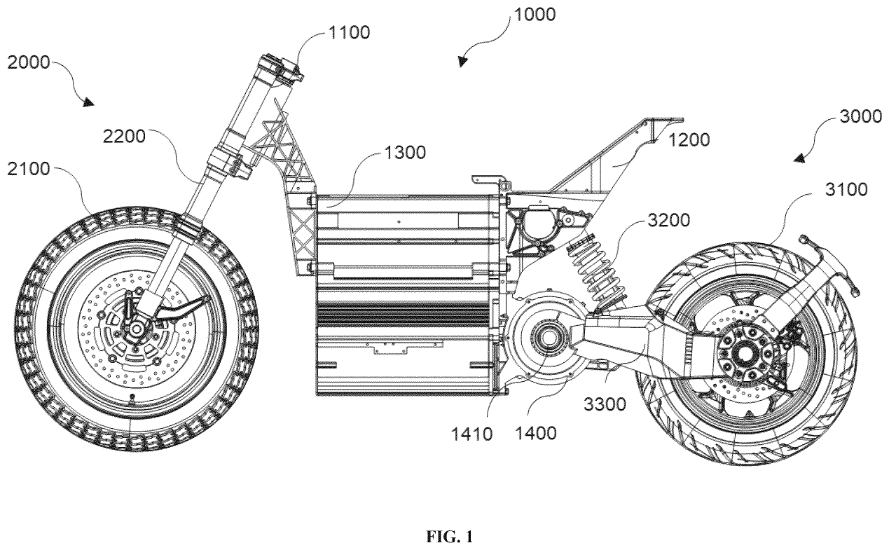

FIG. 1 illustrates an electric motorcycle according to an implementation of the present disclosure. The electric motorcycle may be an all-electric motorcycle, and may also be a hybrid motorcycle driven by an electricity and a fuel. The electric motorcycle includes frame assembly 1000, front suspension system 2000, and rear suspension system 3000.

In the implementation shown in FIG. 1, the frame assembly 1000 includes first frame 1100, second frame 1200, battery 1300, and motor 1400.

The first frame 1100 may be configured to mount the front suspension system 2000 and/or a front steering system. The front suspension system 2000 may include front wheel 2100 and front shock absorber assembly 2200 of the electric motorcycle. The second frame 1200 may be configured to mount the rear suspension system 3000. The rear suspension system 3000 may include rear wheel 3100, rear shock absorber assembly 3200, and rear chainstay 3300 of the electric motorcycle. The rear shock absorber assembly 3200 includes one end mounted on the second frame 1200, and the other end mounted on the rear chainstay 3300. The rear chainstay 3300 includes one end mounted on the rear wheel 3100, and the other end mounted on the motor 1400 through motor bearing 1410. An axis of rotation of the rear chainstay coincides with an axis of rotation of a motor output shaft, such that the rear chainstay may rotate around the motor shaft. In another implementation, the rear wheel 3100, the rear shock absorber assembly 3200, the rear chainstay 3300 and the second frame 1200 may collectively form the rear suspension system of the electric motorcycle.

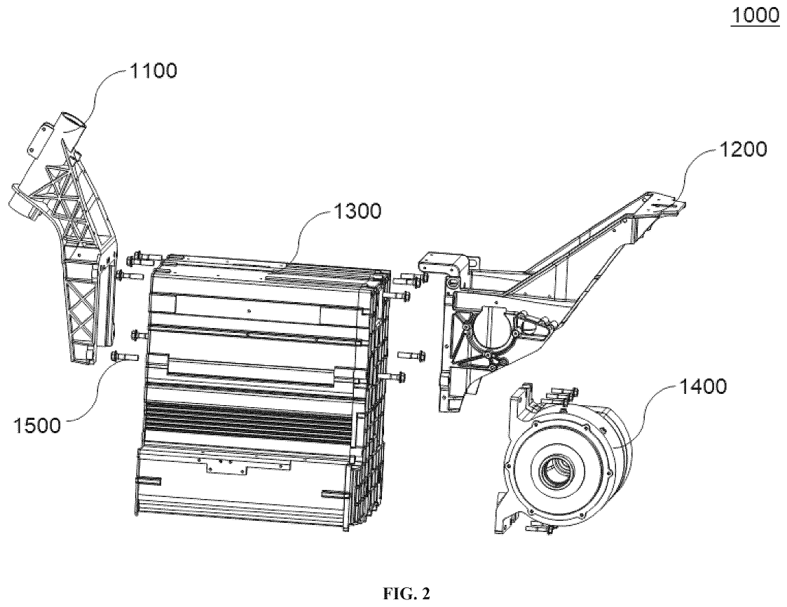

The first frame 1100 may be a front frame of the electric motorcycle and may be mounted to the battery from a first side (front side) of the battery. The second frame 1200 may be a rear frame of the electric motorcycle and may be mounted to the battery from a second side (rear side) of the battery. It is to be understood that within a scope of the present disclosure, the first side and the second side may be any two sides of the battery 1300, such as the front side and the rear side, a left side and a right side, and an upper side and a lower side of the battery, and preferably two opposite sides of the battery. As an example, the first side may be a side of the battery close to a normal heading direction of the electric motorcycle, and the second side may be a side of the battery away from the normal heading direction of the electric motorcycle. It is further to be understood that within the scope of the present disclosure, the term “mounted to from . . . side” indicates a positional relationship between various components, rather than a limit to a specific connection between the various components. For example, the expression “the first frame 1100 is mounted to the battery from the front side of the battery” indicates that upon completion of mounting, the first frame is located at the front side of the battery, rather than a limit to a specific connection direction between the first frame 1100 and the battery. As a matter of fact, even though the first frame is mounted to the battery from the front side of the battery, a longitudinal or transverse connection direction can still be used according to a specific layout of connection components between the first frame and the battery, and a connecting joint surface between the first frame and the battery may also be another side (such as the left side or the right side) of the battery, as described below with reference to FIG. 2 to FIG. 6.

Herein, the motor 1400 may be mounted to the second frame 1200 and/or the battery 1300 from a battery side where the second frame 1200 is located. It is advantageous that the motor 1300 may be mounted to the second frame and the battery at the same time. For example, an upper portion and a lower portion of the motor may be respectively mounted to a lower portion of the second frame 1200 and a lower portion of the battery 1300 from the second side, thereby improving a stability of the motor. It is further advantageous that the motor may form an external permanent magnet synchronous motor. For example, the motor is mounted outside the rear wheel 3100, rather than on the rear wheel, such that the whole suspension frame has better shock absorption performance and the whole motorcycle has better power performance. It is particularly advantageous that the motor and the battery each may include an electrical interface and a fluid interface that may be connected to each other in an insertion manner. Through direct insertion, an electrical connection and a fluid connection between the motor and the battery can be realized.

It is advantageous that the first frame 1100, the second frame 1200, the battery 1300 and the motor 1400 may collectively form a bearing structure of the electric motorcycle to bear a weight of a body, a driver, a passenger and/or other accessories. In this case, the battery and the motor that provide the power can also be used to bear an external force. Therefore, the power system and the bearing system of the electric motorcycle can be at least partially integrated together. This not only can simplify an internal structure and a manufacturing cost of the electric motorcycle, but also further improves function integration of the electric motorcycle. It is further advantageous that the frame structure (or the bearing structure) of the electric motorcycle may exclude other frame members except the first frame and the second frame. In other words, the frame assembly of the electric motorcycle may only include the first frame 1100, the second frame 1200, the battery 1300 and the motor 1400, rather than a battery frame, a motor frame or any frame member connected between the first frame 1100 and the second frame 1200. Within the scope of the present disclosure, the term “frame member” refers to a connecting or bearing frame. The frame member may for example be a frame formed by connecting a sectional material or welding a tubular member, and thus does not have other functions (such as an electric function or a power function). In the present disclosure, it is advantageous that although the battery and the motor are not a real frame member, they may have a similar bearing function as the frame member, and thus can be viewed as a constituent part of the frame assembly.

In a preferred implementation, the first frame 1100, the second frame 1200 and battery housing 1310 may for example be made of an alloy material, preferably a light alloy material such as an aluminum alloy, a copper alloy or an aluminum copper alloy. It is more advantageous that the first frame 1100, the second frame 1200 and the battery housing 1310 may be integrally formed by stamping.

FIG. 2 to FIG. 6 exemplarily illustrate a schematic view of a frame assembly of an electric motorcycle according to different implementations of the present disclosure.

In a preferred implementation, each component in the frame assembly may be detachably connected and fixed through a threaded connection such as a screwed connection or a bolted connection. As shown in FIG. 2, a plurality of threaded holes may be formed in the first frame 1100. A plurality of threaded holes may also be formed in the first side of the battery 1300 and corresponding to the threaded holes in the first frame. A plurality of bolts 1500 may sequentially pass through the threaded holes in the first frame 1100 and the threaded holes in the battery 1300, and are fixed therein, such that the first frame 1100 is fixedly connected to the battery 1300. When the first frame 1100, the front suspension system 2000 or the front wheel assembly of the electric motorcycle is to be replaced, these bolts can be respectively detached from the threaded holes. Thus, the first frame (or the connected front suspension system 2000 or the connected front wheel assembly) can be detached from the battery.

Likewise, a plurality of threaded holes may be formed in the second frame 1200. A plurality of threaded holes may also be formed in the second side of the battery 1300 and corresponding to the threaded holes in the second frame. A plurality of bolts 1500 may sequentially pass through the threaded holes in the second frame 1200 and the threaded holes in the second side of the battery 1300, and are fixed therein, such that the second frame 1200 is fixedly connected to the battery 1300. When the second frame 1200 or the rear suspension system 3000 of the electric motorcycle is to be replaced, these bolts can be respectively detached from the threaded holes. Thus, the second frame (or the connected rear suspension system 3000) can be detached from the battery.

In addition, the upper portion and the lower portion of the motor 1400 each may be provided with a plurality of threaded holes. Accordingly, a plurality of threaded holes corresponding to the threaded holes in the upper portion of the motor may be formed in the second frame 1200. A plurality of threaded holes corresponding to the threaded holes in the lower portion of the motor may be formed in the second side of the battery 1300. Through cooperation between the bolts 1500 and the threaded holes, the upper portion of the motor 1400 can be fixed to the second frame 1200, and the lower portion of the motor can be fixed to the battery 1300. It is advantageous that in this manner, the motor can be fixed on the second frame and at the second side of the battery. Therefore, the motor is mounted firmly and stably, and is not loosened easily due to vibration or an inartificial external factor. In addition, the stable motor is also beneficial for an overall stability of the connected rear suspension system, such that the electric motorcycle achieves better power performance.

Upon completion of mounting, the first frame is provided at the first side of the battery, the second frame is provided at the second side of the battery, and the motor is provided at the second side of the battery and located under the second frame. It is to be noted that there are no limits made on a number of threaded connections and a direction between these components (namely the first frame, the second frame, the battery and the motor) of the frame assembly. For example, a connection (such as a threaded connection) between any two components of the frame assembly may be a transverse connection or a longitudinal connection, and may also be a combination of the transverse connection and the longitudinal connection. Within the scope of the present disclosure, the term “transverse” may refer to a direction parallel to the ground and perpendicular to a central axis of the electric motorcycle, and the term “longitudinal” may refer to a direction parallel to the ground and parallel to the central axis of the electric motorcycle (or the heading direction of the electric motorcycle). It is advantageous that various components in the frame assembly may mainly transmit a force along the longitudinal direction.

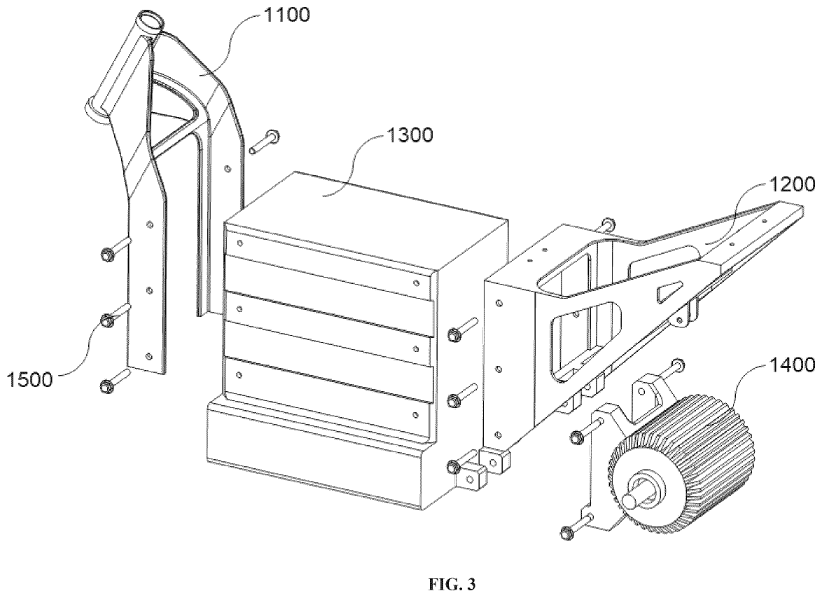

In the implementation shown in FIG. 2, various components (namely the first frame 1100 and the battery 1300, the second frame 1200 and the battery 1300, the motor 1400 and the battery 1300, as well as the motor 1400 and the second frame 1200) in the frame assembly are fixed to each other through the longitudinal connection. In the implementation shown in FIG. 3, various components (namely the first frame 1100 and the battery 1300, the second frame 1200 and the battery 1300, the motor 1400 and the battery 1300, as well as the motor 1400 and the second frame 1200) in the frame assembly are fixed to each other through the transverse connection. In other words, all bolts for connecting the various components in the frame assembly can be inserted into and fixed in corresponding threaded holes along a uniform direction (which is the longitudinal direction in FIG. 2 and the transverse direction in FIG. 3). This can simplify assembly and detachment of the frame assembly, such that the corresponding component of the frame assembly can be quickly detached or replaced if necessary. Moreover, sine the direction of the threaded connection is the same as the force transmission direction of the frame assembly, the bearing capacity and the reliability of the frame assembly can be maximized.

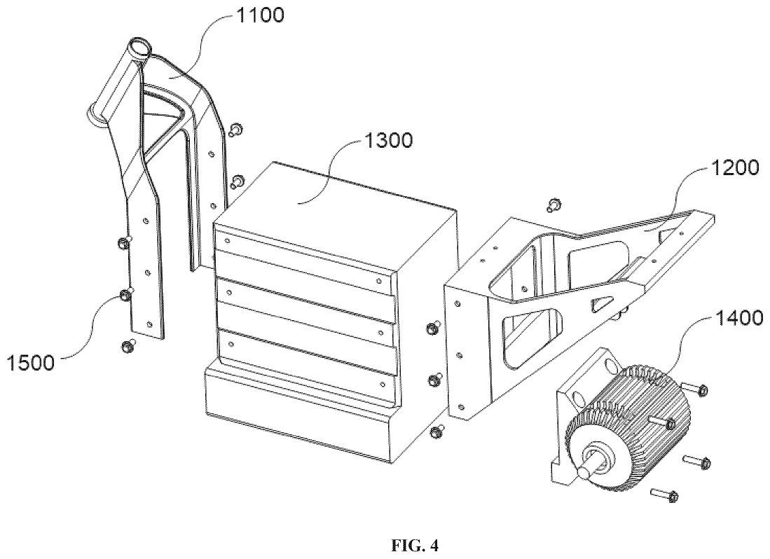

In the implementation shown in FIG. 4, the first frame 1100 and the battery 1300, as well as the second frame 1200 and the battery 1300, are fixed to each other through the transverse connection. The motor 1400 and the battery 1300, as well as the motor 1400 and the second frame 1200, are fixed to each other through the longitudinal connection. Herein, although a joint surface between the battery and the first frame and a joint surface between the battery and the second frame are respectively located at the left side and the right side of the battery due to the transversely extending threaded connection, the first frame and the second frame are still respectively located at the front side and the rear side of the battery relative to the battery. Thus, it is to be understood that the first frame and the second frame are still respectively mounted to the battery from the front side and the rear side of the battery. In the implementation, it is advantageous that a direction of the threaded connection of the motor is different from a direction of the threaded connection of each of the first frame and the second frame, and is preferably perpendicular to the direction of the threaded connection of each of the first frame and the second frame. Thus, connection locking forces of the various components in the frame assembly can be staggered, and the frame assembly can be mounted more firmly.

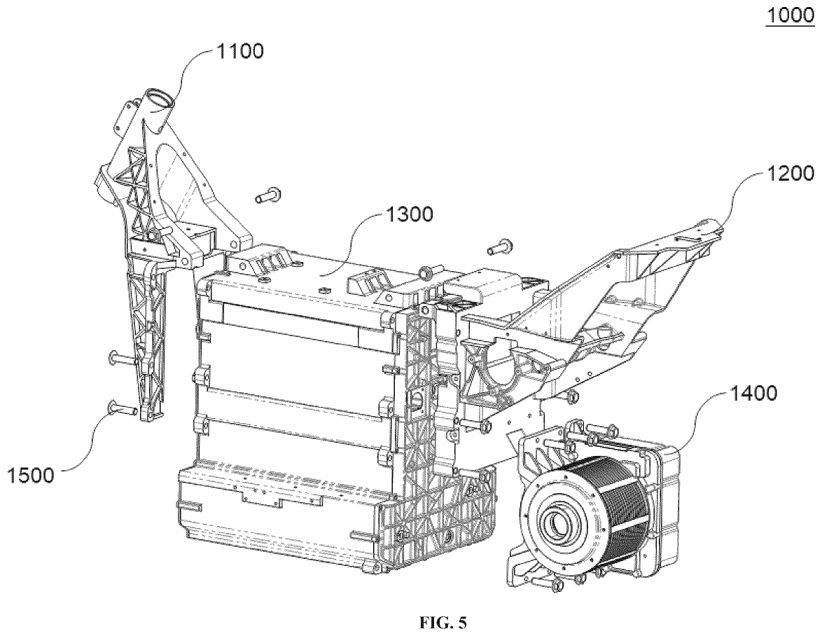

In the implementation shown in FIG. 5, the first frame 1100 and the battery 1300, as well as the second frame 1200 and the battery 1300, are fixed to each other through the transverse connection and the longitudinal connection. The motor 1400 and the battery 1300, as well as the motor 1400 and the second frame 1200, are fixed to each other through the longitudinal connection. It is advantageous that a part or all of the components (such as the first frame and the second frame) in the frame assembly can be fixed through the transverse connection and the longitudinal connection to ensure a connection reliability of these components. It is advantageous that the first frame and the second frame can be connected to the front side, the rear side, the left side and the right side of the battery, and thus a force bearing point of each of the first frame and the second frame for the battery can be dispersed to reduce load integration of the battery.

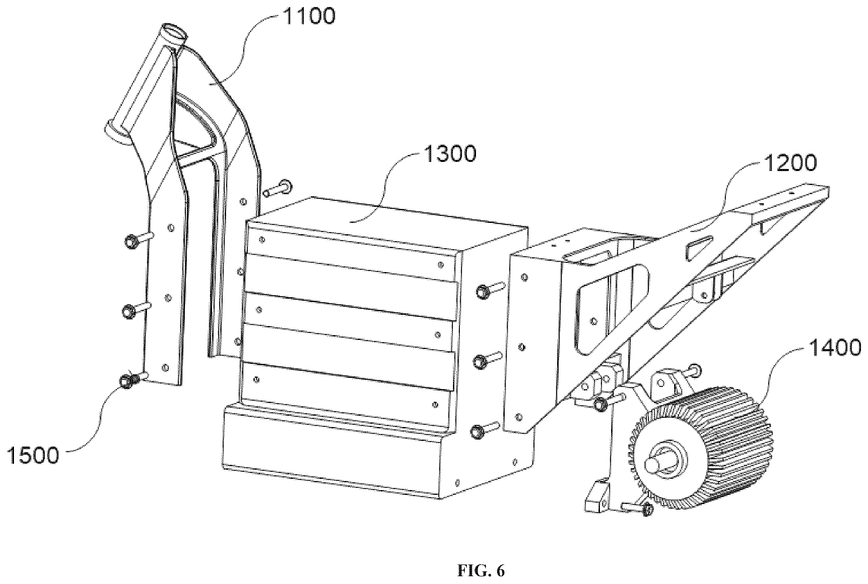

In the implementation shown in FIG. 6, the first frame 1100 and the battery 1300, the second frame 1200 and the battery 1300, as well as the motor 1400 and the second frame 1200, are fixed to each other through the transverse connection. The motor 1400 and the battery 1300 are fixed to each other through the longitudinal connection. It is advantageous that the motor 1400 is fixed on the second frame and on the battery. This can improve a mounting stability of the battery, and can prevent the motor from getting loose due to vibration in operation. It is advantageous that a direction of connecting the motor to the second frame (such as the transverse direction) is different from a direction of connecting the motor to the battery (such as the longitudinal connection). This can make mounting forces of the motor locked to each other, and can improve the mounting reliability of the motor.

It is to be understood that the connection and particularly the connection direction between the various components in the frame assembly are not limited to the above illustrated implementations, but can be adjusted or combined according to a configuration requirement in the body or other structural requirements of the body.

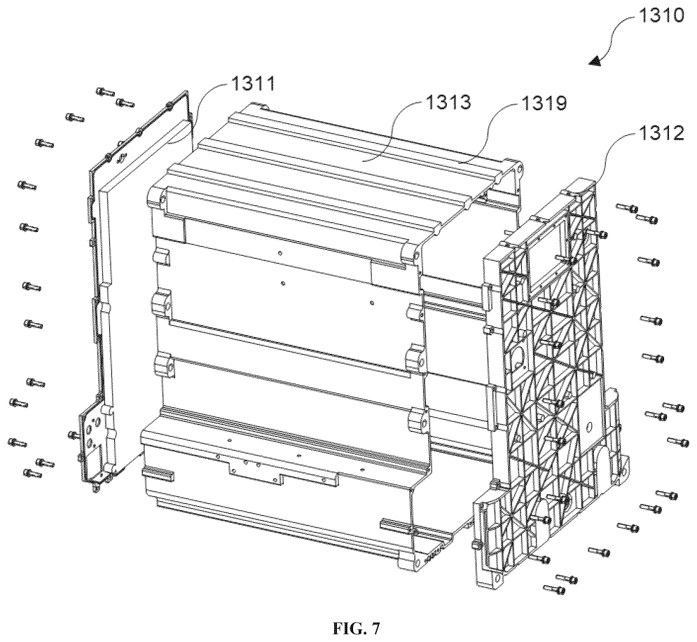

FIG. 7 to FIG. 10 are a schematic structural view of a battery housing according to different implementations of the present disclosure. In an implementation of the present disclosure, the frame assembly may only include the first frame, the second frame, the battery and the motor, without other frame bearing members for bearing various loads of the vehicle in movement. Hence, it is important that the battery and the motor can have a certain bearing capacity, and can be taken as one part of the frame assembly to achieve an additional bearing function. In addition, compared with the motor provided under the second frame, the battery as an intermediate component of the frame assembly requires a higher bearing capacity.

In the implementation shown in FIG. 7, the battery 1300 may further include battery housing 1310 and at least one battery module in the battery housing. In order to improve the bearing capacity of the battery, a plurality of reinforcing ribs 1319 may be provided on the battery housing 1310. It is advantageous that these reinforcing ribs can be provided at each side of the battery, and can extend along a force transmitting direction (longitudinal direction) of the battery, such that the battery can achieve the higher bearing strength.

In addition, the battery housing 1310 may be a segment-wise structure, and may be combined by a plurality of housing components (such as two, three or more housing components). It is advantageous that the segment-wise structure can reduce a forming difficulty of the battery housing, and can lower a manufacturing cost of the battery. As shown in FIG. 7, the battery housing 1310 may include first housing cover 1311, second housing cover 1312, and main housing 1313. The main housing 1313 may be an annular structure with two open ends. The main housing may be integrally formed, for example, by stamping. The two open ends of the housing may be respectively provided with a plurality of threaded holes for mounting the first housing cover 1311 and the second housing cover 1312. The first housing cover 1311 and the second housing cover 1312 each form an end cover member corresponding to a cross section of the main housing, and are provided with threaded holes corresponding to the threaded holes of the main housing. In mounting, bolts may sequentially pass through the threaded holes in the first housing cover, the second housing cover and the main housing, and are fixed therein. It is advantageous that a threaded connection may be provided at an edge of the end of the main housing (around the cross section of the main housing). This not only improves airtightness of the whole battery housing, but also can make the whole battery more rigid.

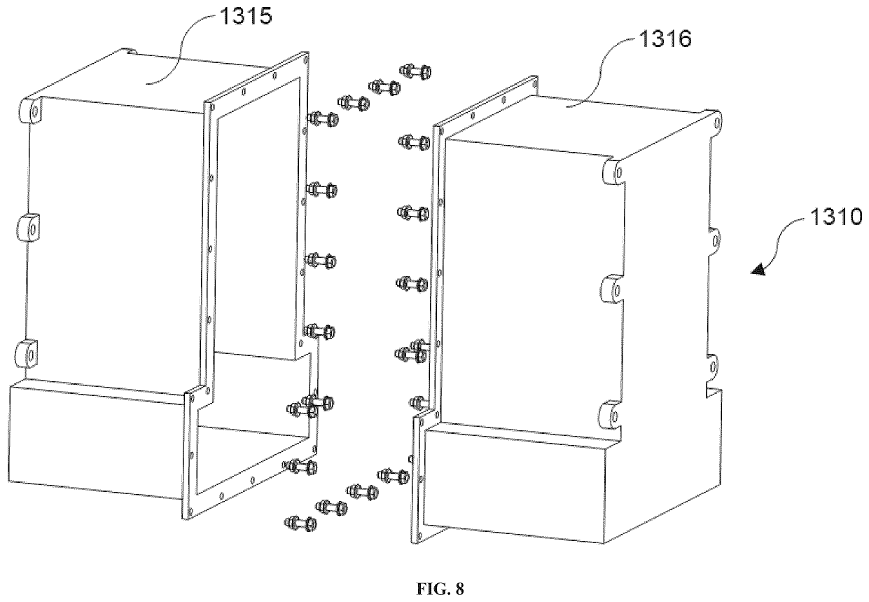

In another implementation shown in FIG. 8, first housing half 1315 and second housing half 1316 may respectively form a front half and a rear half of the battery housing 1310. The front half and the rear half may be two portions defined according to a heading direction and a reversing direction of the electric motorcycle. Likewise, the first housing half 1315 and the second housing half 1316 each are provided with a flange extending along an edge of a cross section of the battery. Corresponding threaded holes are formed in the flange. The first housing half 1315 and the second housing half 1316 can be fixed through a threaded connection (such as a bolted connection) of the flange, thereby forming the sealed battery housing 1310 and making the whole battery more rigid.

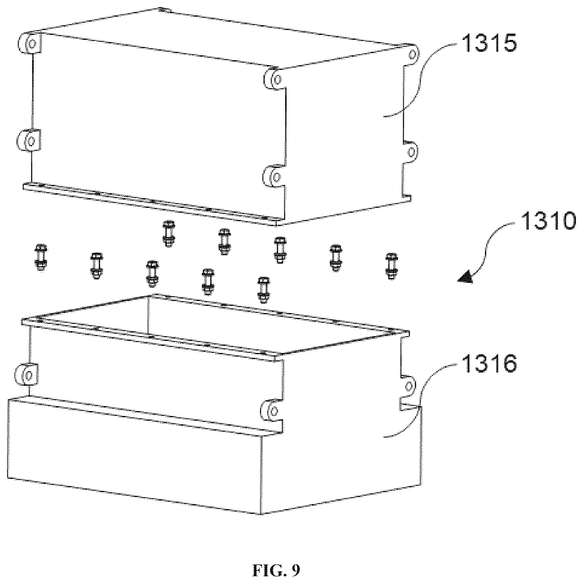

In another implementation shown in FIG. 9, the battery housing 1310 may be combined by the first housing half 1315 and the second housing half 1316. The first housing half 1315 and the second housing half 1316 may respectively form the front half and the rear half of the battery housing 1310. A flange strip extending along the longitudinal direction of the battery is provided on a joint surface of each of the first housing half 1315 and the second housing half 1316. Corresponding threaded holes are formed in the flange strip. The first housing half 1315 and the second housing half 1316 can be fixed to each other through a threaded connection (such as a bolted connection) of the flange strip, thereby forming the sealed battery housing 1310. It is advantageous that the longitudinal extending direction of the flange strip is the same as a main force transmitting direction of the battery housing. This can further improve a rigidity and a bearing strength of the battery housing.

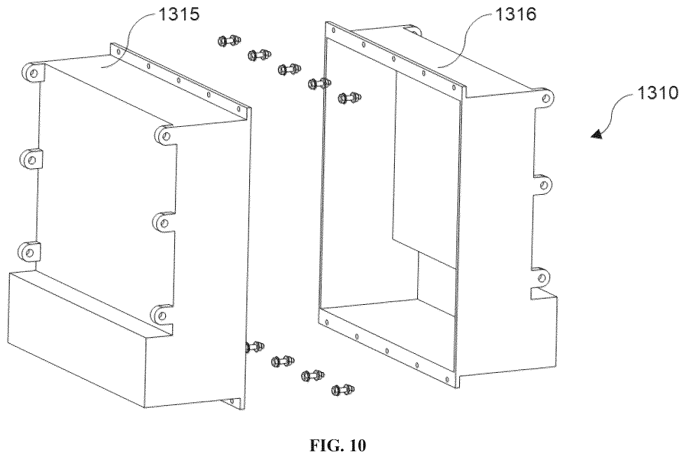

In another implementation shown in FIG. 10, the first housing half 1315 and the second housing half 1316 may respectively form a left half and a right half of the battery housing 1310. The left half and the right half may be two portions defined according to the normal heading direction of the electric motorcycle. Likewise, a flange extending along the longitudinal direction of the battery is provided on each of the two housing halves. Corresponding threaded holes are formed in the flange. The first housing half 1315 and the second housing half 1316 can be fixed to each other through a threaded connection (such as a bolted connection) of the flange, thereby forming the sealed battery housing 1310 and improving the rigidity and the bearing strength of the battery housing. In the implementation shown in FIG. 9 and FIG. 10, it is advantageous that a connection direction (an up-down direction and a left-right direction) of the battery housing is different from a direction (front-rear direction) of mounting each of the first frame and the second frame to the battery. Thus, when the first frame and the second frame are respectively mounted to the battery from the front side and the rear side of the battery, the two housing halves can be locked more firmly to further improve the mounting reliability of the battery housing.

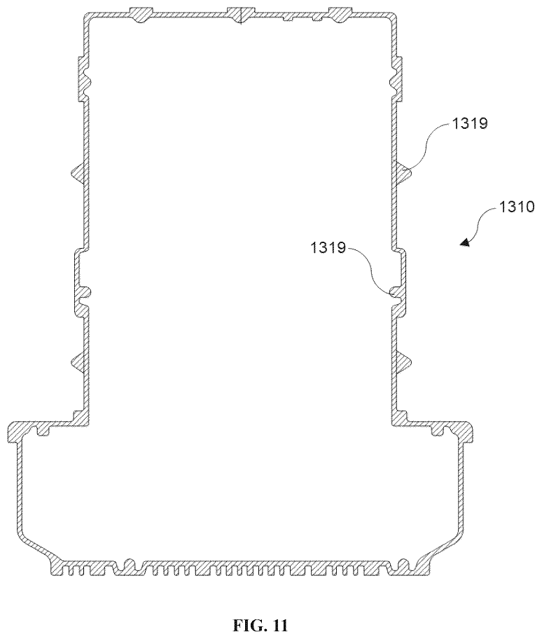

FIG. 11 illustrates an exemplary cross section of the battery housing 1310. The cross section is obtained by cutting the battery housing along a vertical direction. In the example, the section may be of a convex shape. In other examples, the section may be of a rectangular shape or an approximately rectangular shape. It is advantageous that a length direction of the section is the same as a direction of gravity (a direction of an external force applied to the battery). This can improve bending performance of the battery housing in a force direction.

In addition, it is advantageous that as shown by a triangular, square or semicircular bump extending out from the convex section in the figure, the reinforcing ribs 1319 can be provided inside and outside the battery housing. The reinforcing ribs preferably extend along the longitudinal direction of the battery, thereby further improving the strength of the battery housing. It is particularly advantageous that the reinforcing ribs 1319 inside the battery housing can be connected to a connecting beam for fixing the battery module, such that the reinforcing ribs 1319 inside the battery housing can further be additionally used to mount the battery module. Specifically, the connecting beam can be mounted between the reinforcing ribs that are located on opposite surfaces and have a same height, so as to fix the battery module and bear a weight of the battery module. Each battery module can be sequentially stacked in the battery housing. Upon completion of mounting, the battery housing can be integrated with the stacked battery module. This can further increase the overall rigidity of the battery, such that the battery can be taken as the bearing structural member of the frame assembly.

The present disclosure realizes the frame assembly for an electric motorcycle and the electric motorcycle through the following implementations. The power system and the bearing system of the electric motorcycle are at least partially integrated together. The frame structure of the electric motorcycle may exclude other frames except the front frame and the rear frame. The motor and the battery are used as the bearing member of the frame assembly. This at least can simplify an internal structure and a manufacturing cost of the electric motorcycle, and improve function integration of the electric motorcycle.

Item 1. A frame assembly for an electric motorcycle includes a first frame, a second frame, a battery, and a motor, where the first frame and the second frame are respectively mounted to the battery from a first side and a second side of the battery, and the motor is mounted to the battery and/or the second frame from the second side; and the first side and the second side are opposite sides of the battery.

Item 2. The frame assembly according to item 1, where the first frame, the second frame, the battery and the motor collectively form a bearing structure of the electric motorcycle.

Item 3. The frame assembly according to item 1, where the frame assembly excludes other frame members except the first frame and the second frame.

Item 4. The frame assembly according to item 3, where the frame assembly excludes a motor frame, a battery frame, a main frame or a frame member connected between the first frame and the second frame.

Item 5. The frame assembly according to item 1, where the first frame is configured to mount a front suspension system of the electric motorcycle, and the front suspension system includes a front shock absorber assembly and/or a front wheel; and the second frame is configured to mount a rear suspension system of the electric motorcycle, and the rear suspension system includes a rear shock absorber assembly, a rear chainstay and/or a rear wheel.

Item 6. The frame assembly according to item 1, where the motor is mounted out of a hub of the electric motorcycle.

Item 7. The frame assembly according to item 1, where the battery includes at least one battery module and a battery housing, and the at least one battery module is located in the battery housing.

Item 8. The frame assembly according to item 1, where the first side is a side of the battery close to a heading direction of the electric motorcycle, and the second side is a side of the battery away from the heading direction of the electric motorcycle.

Item 9. The frame assembly according to any one of items 1 to 8, where the first frame, the second frame and/or the battery housing are integrally formed.

Item 10. The frame assembly according to item 9, where the first frame, the second frame and/or the battery housing are integrally formed by an aluminum alloy.

Item 11. The frame assembly according to any one of items 1 to 8, where the motor is connected to the rear chainstay of the electric motorcycle through a bearing, and an axis of rotation of a motor shaft of the motor coincides with an axis of rotation of the rear chainstay.

Item 12. The frame assembly according to any one of items 1 to 8, where an electrical interface and/or a fluid interface of the motor is connected to an electrical interface and/or a fluid interface of the battery in an insertion manner.

Item 13. The frame assembly according to any one of items 1 to 8, where the first frame and the battery, the second frame and the battery, the motor and the battery, and/or the motor and the second frame are fixed to each other by a detachable connection.

Item 14. The frame assembly according to item 13, where the detachable connection includes a longitudinal connection and/or a transverse connection.

Item 15. The frame assembly according to item 14, where the first frame and the battery, the second frame and the battery, the motor and the battery, as well as the motor and the second frame, are fixed to each other through the longitudinal connection.

Item 16. The frame assembly according to item 14, where the first frame and the battery, the second frame and the battery, the motor and the battery, as well as the motor and the second frame, are fixed to each other through the transverse connection.

Item 17. The frame assembly according to item 14, where the first frame and the battery, as well as the second frame and the battery, are fixed to each other through the transverse connection; and the motor and the battery, as well as the motor and the second frame, are fixed to each other through the longitudinal connection.

Item 18. The frame assembly according to item 14, where the first frame and the battery, as well as the second frame and the battery, are fixed to each other through the transverse connection and the longitudinal connection; and the motor and the battery, as well as the motor and the second frame, are fixed to each other through the longitudinal connection.

Item 19. The frame assembly according to item 14, where the first frame and the battery, the second frame and the battery, as well as the motor and the second frame, are fixed to each other through the transverse connection; and the motor and the battery are fixed to each other through the longitudinal connection.

Item 20. The frame assembly according to any one of items 1 to 8, where the battery housing has a rectangular or convex vertical section.

Item 21. The frame assembly according to item 7, where a reinforcing rib extending along a longitudinal direction of the battery is provided outside and/or inside the battery housing.

Item 22. The frame assembly according to item 21, where the reinforcing rib inside the battery housing is configured to connect the battery module and/or mount a connecting beam.

Item 23. The frame assembly according to any one of items 1 to 8, where the battery housing includes a plurality of housing components.

Item 24. The frame assembly according to item 23, where the battery housing includes a first housing cover, a second housing cover, and a main housing; the first housing cover and the second housing cover are respectively connected to two sides of the main housing; and the main housing is integrally formed.

Item 25. The frame assembly according to item 23, where the battery housing includes a first housing half and a second housing half; and the first housing half and the second housing half are fixed to each other through a threaded connection.

Item 26. The frame assembly according to item 25, where the first housing half and the second housing half each include a flange for the threaded connection, and the flange extends along a longitudinal direction of the battery.

Item 27. The frame assembly according to item 25, where the first housing half and the second housing half respectively form an upper housing half and a lower housing half, a left housing half and a right housing half, or a front housing half and a rear housing half of the battery housing.

Item 28. An electric motorcycle, including the frame assembly according to any one of items 1 to 27.

Item 29. The electric motorcycle according to item 28, where the electric motorcycle is an all-electric motorcycle or a gasoline-electric hybrid motorcycle.

The above merely describes preferred specific implementations of the present disclosure, but the protection scope of the present disclosure is not limited thereto. Any person skilled in the art can easily conceive modifications or replacements within the technical scope of the present disclosure, and these modifications or replacements shall fall within the protection scope of the present disclosure. Therefore, the protection scope of the present disclosure shall be subject to the protection scope of the claims.

1. A frame assembly for an electric motorcycle, comprising:
a first frame, a second frame, a battery, and a motor,
wherein the first frame and the second frame are respectively mounted to the battery from a first side and a second side of the battery, and the motor is mounted to the battery and/or the second frame from the second side; and
the first side and the second side are opposite sides of the battery.

2. The frame assembly according to claim 1, wherein
the first frame, the second frame, the battery and the motor collectively form a bearing structure of the electric motorcycle.

3. The frame assembly according to claim 1, wherein
the frame assembly excludes other frame members except the first frame and the second frame.

4. The frame assembly according to claim 3, wherein
the frame assembly excludes a motor frame, a battery frame, a main frame or a frame member connected between the first frame and the second frame.

5. The frame assembly according to claim 1, wherein
the first frame is configured to mount a front suspension system of the electric motorcycle, and the front suspension system comprises a front shock absorber assembly and/or a front wheel; and
the second frame is configured to mount a rear suspension system of the electric motorcycle, and the rear suspension system comprises a rear shock absorber assembly, a rear chainstay and/or a rear wheel.

6. The frame assembly according to claim 1, wherein
the motor is mounted out of a hub of the electric motorcycle.

7. The frame assembly according to claim 1, wherein
the battery comprises at least one battery module and a battery housing, and the at least one battery module is located in the battery housing.

8. The frame assembly according to claim 1, wherein
the first side is a side of the battery close to a heading direction of the electric motorcycle, and the second side is a side of the battery away from the heading direction of the electric motorcycle.

9. The frame assembly according to any one of claims 1 to 8, wherein
the first frame, the second frame and/or the battery housing are integrally formed.

10. The frame assembly according to claim 9, wherein
the first frame, the second frame and/or the battery housing are integrally formed by an aluminum alloy.

11. The frame assembly according to any one of claims 1 to 8, wherein
the motor is connected to the rear chainstay of the electric motorcycle through a bearing, and an axis of rotation of a motor shaft of the motor coincides with an axis of rotation of the rear chainstay.

12. The frame assembly according to any one of claims 1 to 8, wherein
an electrical interface and/or a fluid interface of the motor is connected to an electrical interface and/or a fluid interface of the battery in an insertion manner.

13. The frame assembly according to any one of claims 1 to 8, wherein
the first frame and the battery, the second frame and the battery, the motor and the battery, and/or the motor and the second frame are fixed to each other by a detachable connection.

14. The frame assembly according to claim 13, wherein
the detachable connection comprises a longitudinal connection and/or a transverse connection.

15. The frame assembly according to claim 14, wherein
the first frame and the battery, the second frame and the battery, the motor and the battery, as well as the motor and the second frame, are fixed to each other through the longitudinal connection.

16. The frame assembly according to claim 14, wherein
the first frame and the battery, the second frame and the battery, the motor and the battery, as well as the motor and the second frame, are fixed to each other through the transverse connection.

17. The frame assembly according to claim 14, wherein
the first frame and the battery, as well as the second frame and the battery, are fixed to each other through the transverse connection; and
the motor and the battery, as well as the motor and the second frame, are fixed to each other through the longitudinal connection.

18. The frame assembly according to claim 14, wherein
the first frame and the battery, as well as the second frame and the battery, are fixed to each other through the transverse connection and the longitudinal connection; and
the motor and the battery, as well as the motor and the second frame, are fixed to each other through the longitudinal connection.

19. The frame assembly according to claim 14, wherein
the first frame and the battery, the second frame and the battery, as well as the motor and the second frame, are fixed to each other through the transverse connection; and
the motor and the battery are fixed to each other through the longitudinal connection.

20. The frame assembly according to any one of claims 1 to 8, wherein
the battery housing has a rectangular or convex vertical section.

21. The frame assembly according to claim 7, wherein
a reinforcing rib extending along a longitudinal direction of the battery is provided outside and/or inside the battery housing.

22. The frame assembly according to claim 21, wherein
the reinforcing rib inside the battery housing is configured to connect the battery module and/or mount a connecting beam.

23. The frame assembly according to any one of claims 1 to 8, wherein
the battery housing comprises a plurality of housing components.

24. The frame assembly according to claim 23, wherein
the battery housing comprises a first housing cover, a second housing cover, and a main housing;
the first housing cover and the second housing cover are respectively connected to two sides of the main housing; and
the main housing is integrally formed.

25. The frame assembly according to claim 23, wherein
the battery housing comprises a first housing half and a second housing half; and
the first housing half and the second housing half are fixed to each other through a threaded connection.

26. The frame assembly according to claim 25, wherein
the first housing half and the second housing half each comprise a flange for the threaded connection, and the flange extends along a longitudinal direction of the battery.

27. The frame assembly according to claim 25, wherein
the first housing half and the second housing half respectively form an upper housing half and a lower housing half, a left housing half and a right housing half, or a front housing half and a rear housing half of the battery housing.

28. An electric motorcycle, comprising the frame assembly according to any one of claims 1 to 27.

29. The electric motorcycle according to claim 28, wherein the electric motorcycle is an all-electric motorcycle or a gasoline-electric hybrid motorcycle.
